(19) United States
(12) Patent Application Publication
(10) Pub. No.: US 2019/0310618 A1
(43) Pub. Date: Oct. 10, 2019

(54) SYSTEM AND SOFTWARE FOR UNIFYING MODEL-BASED AND DATA-DRIVEN FAULT DETECTION AND ISOLATION

(71) Applicant: Hitachi, Ltd., Tokyo (JP)

(72) Inventors: Hamed Ghazavi KHORASGANI, San Jose, CA (US); Ahmed Khairy FARAHAT, Santa Clara, CA (US); Kosta RISTOVSKI, San Jose, CA (US); Chetan GUPTA, San Mateo, CA (US)

(73) Assignee: Hitachi, Ltd.

(21) Appl. No.: 15/947,651

(22) Filed: Apr. 6, 2018

(51) Int. Cl. G05B 23/02; G06K 9/62

(52) U.S. Cl. CPC G05B 23/0254; G05B 23/0281; G05B 23/0221; G05B 17/02; G06K 9/6267; G06K 9/6218; G05B 23/0229

(57) ABSTRACT

Example implementations described herein are directed to a system and software for integrating model-based and data-driven diagnosis solutions, automatically generating residuals in dynamic systems and using these residuals for fault detection and isolation (FDI), and automatic fault identification. Through a combination of a model-based approach and a data-driven approach for generating residuals and applying the residuals to detect, isolate and identify faults in a physical system can be obtained.

### BACKGROUND

### Field

The present disclosure is directed to fault detection and isolation, and more specifically, to unifying model-based and data-driven approaches for fault detection and isolation.

### Related Art

Unpermitted deviations of system characteristics and parameters from standard conditions are referred to as faults in the system. Faults can put the operators at risk, disrupt the manufacturing processes and cost industries millions of dollars. Fault detection determines the occurrence of a fault and the fault occurrence time in the system. In the next step, fault isolation determines the kind and location of the detected fault. Finally, fault identification determines the size and time-varying behavior of the isolated fault. Timely fault detection, isolation and identification can be critical for the safety of system operators, and can help them to prevent abnormal event progression and reduce downtime and productivity loss.

Model-based diagnosis methods rely on a model that defines nominal behavior of a dynamic system to detect abnormal behaviors and isolate faults. FIG. 1 illustrates general processes in model-based fault detection and isolation. Data 100 is provided to a residual generation module 101 that is then used in hypothesis tests 102 and processed by decision logic 103 to determine if the process is nominal 104 or if fault modes are detected 105.

Residuals are fault indicators. Residual generation can be an important step in model-based fault detection and isolation (FDI). To detect a fault, f, model-based approaches require a residual sensitive to the fault and, at the same time, invariant or at least robust to uncertainties and noise in the system. To isolate a fault fᵢ from another fault fᵢ requires a residual sensitive to fᵢ and at the same time insensitive to fᵢ and other uncertainties present in the system.

Analytical redundancy-based methods are among the most common related art approaches for residual generation. Such methods use two or more ways to determine the same variable, where at least one way uses model equations. A possible inconsistency between the two or more values derived for the same variable is considered as a fault indicator. To make a diagnosis robust to noise and uncertainties, typically, a hypothesis test 102 such as Z-test is used to determine if a residual deviation is statistically significant. In the last step, a fault isolation algorithm uses a decision logic 103 to generate possible fault candidates based on the hypothesis tests outputs.

Data-driven diagnosis algorithms detect and isolate system faults by operating exclusively on system measurements and using very little knowledge about the system. FIG. 2 illustrates a generic approach to data-driven diagnosis methods.

For data-driven methods, fault detection and isolation is addressed in two steps; 1) feature selection and feature extraction 201 and 2) fault classification 202. The first step is designed to extract a set of relevant features from measurement data. In the related art, this would represent subset of measurements that are sensitive to the faults and, at the same time, are invariant or at least robust to noise and disturbances in the system. Among feature extraction methods, Principal Components Analysis (PCA) is the most widely used in the related art. It generates a set of orthogonal bases in the directions where the data has the greatest variances.

The second step maps the features to the nominal operating mode or different fault modes. Several surveys and review articles have categorized data-driven fault detection and isolation approaches based on the method applied for fault classification in the second step. Generally, they fall into two main groups: 1) supervised, and 2) unsupervised. The supervised approaches assume the training data is labeled by instances for the normal and fault classes. These methods apply classifier methods such as neural networks or Bayesian networks to map the features to the system fault modes.

The unsupervised approaches do not start with labeled data. These methods make the implicit assumption that normal instances are far more frequent than faulty data points in the test dataset and use a clustering approach to divide up the data points into multiple groups. The next step is an interpretation process, where depending on the set of features that distinguish each group, labels are associated with the different groups. In some cases, the groups may represent fault conditions.

In the related art, the performances of a model-based fault detection method were compared based on analytical redundancy relations with a data-driven scheme for fault detection and isolation using linear discriminant analysis applied to internal combustion engine. The analysis showed that both methods delivered high detection rates and low false alarm rates for engine diagnosis. Model-based diagnosis have also been combined with data-driven approaches to achieve better diagnosis performance. In a related art implementation, a model-based approach was used for fault detection. In such an implementation, the residual outputs were used from previous fault scenarios to train a one-class support vector machine (1-SVM) for fault isolation. If the new sample did not correspond to the nominal or one of the known fault modes, it was labeled as a likely unknown fault. The classifiers were expected to become more accurate as more data was collected over time.

In related art implementations, support vector machines (SVM) were utilized for fault detection and applied an observer-based diagnosis approach for fault isolation. When the SVM detects no fault in the system, such implementations use the data to update the observer parameters.

In related art implementations, a hybrid diagnosis approach that combines the use of historical data with the available physics based knowledge of the system to achieve better diagnosis performance in smart buildings with incomplete models were introduced. Through combining model-based diagnosis and data-driven anomaly detection such implementations can detect and isolate faults that were not possible with pure model-based diagnosis approaches because the models were incomplete. By integrating model-based and data-driven methods, such implementations can use the system model and historical data to achieve better diagnosis performances.

### SUMMARY

In this invention, we introduce a general unified framework that can be used to integrate different methodologies developed by data-driven and model-based research communities to use various sources of knowledge for fault detection and isolation. Unlike previous hybrid diagnosis methods, our proposed framework is not limited to specific model-based and data-driven methods and can be used to integrate different model-based and data-driven methods. A unified diagnosis method can address the following issues.

Incomplete models: for complex systems, the system diagnostics models may not be easy to develop, and keep updated during the system life-cycle. Therefore, reliable models of these systems are not always available. Even when models are available, they are often incomplete and plagued by uncertainties in tracking system behavior. This can lead to high false positive or high false negative rates in model-based diagnosis. In these situations where diagnosis models are not very accurate, their imperfections and incompleteness can be overcome by supplementing them with additional operational data from the system. For example, by using data-driven features extracted from the historical data in addition to the residuals derived from the model, the false positive and false negative rates can be decreased.

Insufficient historical data: in the real world, access to training data to learn the normal behaviors of the system in all the different operating modes may not be readily available. Having access to labeled data for faulty operations is even more expensive and difficult. Integrating model-based diagnosis methods with data-driven approaches can address these problems. Physics-based models can be used to generate data for normal operating modes and faulty behavior. This artificially generated data can be used to enrich the training data. Moreover, the residuals, generated from system equations, can be used as additional features in data-driven diagnosis methods to improve diagnosis performance.

Through the example implementations as described herein, fault detection can be conducted and diagnosis and rectification of faults can be executed even if models to determine faults are incomplete, or the historical data is lacking. Thus, more faults can be accurately detected and treated without requiring complete models or historical data as is typically required by related art implementations.

Aspects of the present disclosure include a method for fault detection by an apparatus managing a plurality of systems, the method including receiving data from a system from the plurality of systems; determining available feature extraction frameworks of the system from the plurality of systems, the available feature extraction frameworks determined based on availability of system models, domain knowledge-based features, and data driven features of the system; determining if the system models that model physics of the system are available from the management information; for the system models that model physics of the system determined to be available from the management information, conducting feature extraction for the system from a combination of all of the available system models with all available feature extraction frameworks as applied to the received data to derive extracted features; and determining faults of the system from the extracted features and the received data.

Aspects of the present disclosure further includes a non-transitory computer readable medium, storing instructions for fault detection by an apparatus managing a plurality of systems, the instructions including receiving data from a system from the plurality of systems; determining available feature extraction frameworks of the system from the plurality of systems, the available feature extraction frameworks determined based on availability of system models, domain knowledge-based features, and data driven features of the system; determining if the system models that model physics of the system are available from the management information; for the system models that model physics of the system determined to be available from the management information, conducting feature extraction for the system from a combination of all of the available system models with all available feature extraction frameworks as applied to the received data to derive extracted features; and determining faults of the system from the extracted features and the received data.

Aspects of the present disclosure further includes a management apparatus configured to manage a plurality of systems, the management apparatus involving a processor, configured to: receive data from a system from the plurality of systems; determine available feature extraction frameworks of the system from the plurality of systems, the available feature extraction frameworks determined based on availability of system models, domain knowledge-based features, and data driven features of the system; determine if the system models that model physics of the system are available from the management information; for the system models that model physics of the system determined to be available from the management information, conduct feature extraction for the system from a combination of all of the available system models with all available feature extraction frameworks as applied to the received data to derive extracted features; and determine faults of the system from the extracted features and the received data.

Aspects of the present disclosure further includes an apparatus managing a plurality of systems, the apparatus including means for receiving data from a system from the plurality of systems; means for determining available feature extraction frameworks of the system from the plurality of systems, the available feature extraction frameworks determined based on availability of system models, domain knowledge-based features, and data driven features of the system; means for determining if the system models that model physics of the system are available from the management information; for the system models that model physics of the system determined to be available from the management information, means for conducting feature extraction for the system from a combination of all of the available system models with all available feature extraction frameworks as applied to the received data to derive extracted features; and means for determining faults of the system from the extracted features and the received data.

### BRIEF DESCRIPTION OF THE DRAWINGS

FIG. 1 illustrates general steps in model-based fault detection and isolation.

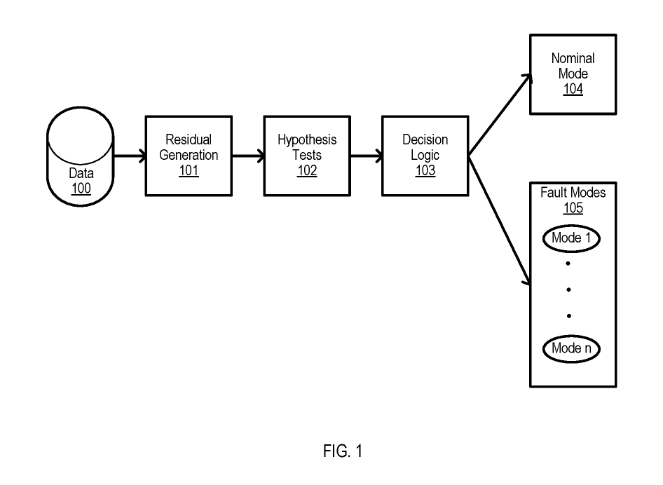

FIG. 2 illustrates a generic approach to data-driven diagnosis methods.

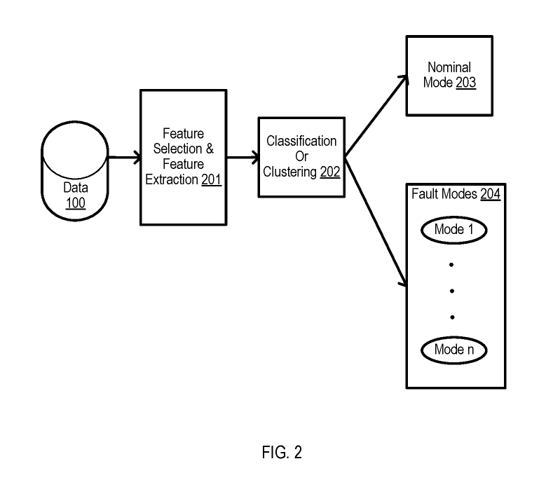

FIG. 3 illustrates a modified framework in accordance with an example implementation.

FIG. 4(a) illustrates the residual generation method, in accordance with an example implementation.

FIG. 4(b) illustrates an example flow for finding determined sets of equations, in accordance with an example implementation.

FIG. 4(c) illustrates example feature extraction methods that can be applied in example diagnosis software and systems, in accordance with an example implementation.

FIG. 5 illustrates an example of fault detection and isolation through using classifiers in accordance with an example implementation.

FIG. 6 illustrates an example usage of the hypothesis test and decision logic for fault detection and isolation, in accordance with an example implementation.

FIG. 7(a) illustrates an example of utilizing an unsupervised approach for fault detection and isolation, in accordance with an example implementation.

FIG. 7(b) illustrates examples of different fault diagnosis methods that can be implemented based on different scenarios involving the availability of normal data and data indicative of faults.

FIG. 8(a) illustrates the fault identification method, in accordance with an example implementation.

FIG. 8(b) illustrates a flow for finding determined sets for fault identification, in accordance with an example implementation.

FIG. 9 illustrates a nonlinear electric circuit system, in accordance with an example implementation.

FIG. 10 illustrates an example residual generation for the electric circuit of FIG. 9.

FIG. 11 illustrates an example fault identification for the electric circuit system of FIG. 9.

FIG. 12 illustrates an example overall flow, in accordance with an example implementation.

FIG. 13 illustrates a plurality of systems and a management apparatus, in accordance with an example implementation.

FIG. 14 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

The fault detection and isolation community have developed model-based and data-driven solutions for monitoring complex systems. Recently, several researchers have reported improvement in diagnosis performance by combining model-based and data-driven techniques. The focus of such research has been on borrowing specific techniques from other domains to improve diagnosis performance of a given method and do not provide a systematic approach for the integration process.

In the present disclosure, example implementations can illustrate that model-based and data-driven diagnosis methods can be represented in a common general framework. The general framework divides each diagnosis algorithm, whether it is data-driven or model-based, into three main steps. Example implementations described herein then represent an integration process for each diagnosis step. Unlike previous integrated diagnosis methods, the proposed framework of example implementations is not limited to specific model-based and data-driven methods and can be used to build crossover solutions that integrate techniques developed by different research communities.

In addition to the proposed framework, example implementations involve an algorithm for automated residual generation in model-based fault detection and isolation. State of the art methods for automated residual generation cannot generate residuals for complex nonlinear systems with implicit functions. To address this problem, example implementations described herein adopt a recursive numerical method to estimate the value of residuals at each sample point. Moreover, the recursive numerical approach is modified to estimate the fault value after fault detection and isolation. The resultant implementation of analytical redundancy approaches for fault identification is novel in comparison to the implementations of the related art. Extending the residual generation method to fault identification can guarantee the estimation of any isolated fault.

Unifying Framework

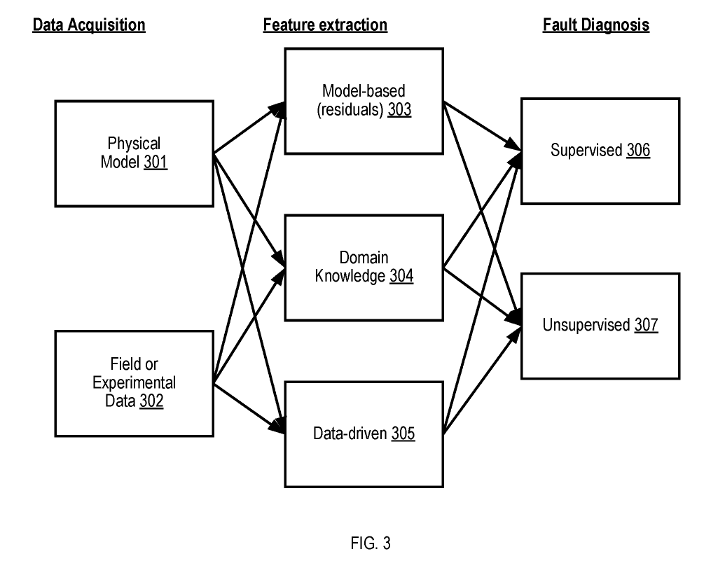

Example implementations facilitate a solution to integrate data-driven and model-based diagnosis methods in a unified framework is shown in FIG. 3. In example implementations, the diagnosis framework has three main steps; 1) data acquisition, 2) feature extraction, 3) fault detection and isolation (fault diagnosis).

Most of the diagnosis methods can be presented in this framework. Representing different diagnosis solutions in the same framework, is the first step in building crossover diagnosis solutions. Using our framework, each diagnosis approach is divided into three main steps. For each step, a systematic approach is developed for the integration.

Input data: A key aspect of any fault diagnosis method is the selection of the input data that is relevant for detecting and isolating faults. The input data can be collected by sensors that are part of the system, and provide information on system operations. The input data can also include data generated by conducting experimental tests, or from simulation data generated by simulators. In other words, the input data is categorized for the diagnosis methods into three main groups.

Field/Experimental data 302: The goal of any health monitoring strategy is to detect and isolate faults in real operational situations. Therefore, field data gathered during the system operation is the most reliable data source for training and test purposes. However, as described above, the field data that represents all the operating modes of the system including fault modes is rarely available. An alternative approach is to run the system in different experimental scenarios to understand the system behavior in different operating modes, and the effect of faults and how they evolve over time. The experimental data can be used for designing diagnosis methods and for testing the existing approaches. However, running experiments especially under faulty conditions can be expensive and in many cases infeasible.

Simulation data: Real fault data may not always be available. In that case, system experts can use simulators to generate faulty data, which can then be used to design detectors and diagnosers. Such an approach is similar to the experimental method. However, using the system model 301 to explore fault scenarios is more cost efficient. The disadvantage of this method is that an accurate physical model of the system is required. Developing accurate models for complex systems is not trivial. Modeling the fault scenarios is even more challenging.

A combination of data sources can be used to generate hybrid diagnosis methods. Our software allows a combination of sources to be used for data acquisition. Since the models are not always completely accurate, we prioritize using the field data and experimental data in our diagnosis software. For the operating conditions and the fault modes where the field data and experimental data are not available, our software allows the users to upload simulation data.

Note that simulation data is often generated at different levels of detail compared to field and experimental data. In real systems, there are a limited number of sensors with specific sampling rates, however, in simulation experiments, any variable can be recorded at any desired rate. To blend the simulation data with real world data, only the variables associated with system sensors are used and example implementations perform a re-sampling approach to create consistent sampling rates in data coming from different sources.

Feature Extraction: Typically, it is not feasible to design accurate fault detectors and isolators for dynamic systems by only monitoring the raw data generated by sensors. Moreover, some measurements can be noisy or irrelevant to the faults. Therefore, as part of developing diagnosis approaches, there have been developed methods for selecting a set of features that are sufficient for detecting and isolating a set of faults that are of interest. The feature extraction can be done using three main resources; 1) the domain expert knowledge 304, 2) the system dynamic model 303, and 3) system historical data 305. The features generated using system dynamic model are referred to as residuals.

In the example implementations described herein, the general feature extraction methods are reviewed, and features generated from different resources are combined. Example implementations involve a numerical model-based residual generation algorithm which makes automated residual generation (model-based feature extraction) possible for more complex systems.

Domain knowledge 304: Traditionally, health monitoring engineers and domain experts have used their knowledge of the system to extract a set of features that can be used to detect and isolate system faults. The bipartite graph that represents the relationship between features and system faults is called the diagnosis reference model and has been used widely in monitoring complex systems. In example implementations described herein, the users are provided with the ability to select the important features for fault diagnosis as the initial feature selection step. However, the selected features by domain experts are often incomplete, which can impair fault detection and isolation performance. Therefore, example implementations described herein use model-based and data-driven techniques to extract additional features for fault detection and isolation.

Model based residual generation 303: When the system model is available, it is possible to use the model equations to derive a set of residuals for fault detection and isolation. Typically, the engineers and domain experts use the system equations to derive the set of residuals. Deriving the set of residuals by domain experts can render designing monitoring systems expensive and inefficient. Several different algorithms have been proposed for automated residual generation using analytical redundancy methods. Automated residual generation reduces the cost of designing diagnosis systems significantly.

A set of equations is determined if the number of equations are equal to the number of variables. The automated residual generation approach involves picking determined subsets of equations that include measurement variables and solving the equation sets for the measurement variables numerically. Differences between the measurements and the computed value of the measurements are residuals. In fact, to generate a residual, the value of a measurement is computed from using other measurements in the system. The difference between the computed value and the actual measurement is a residual that can be used for fault detection and isolation. Therefore, finding a minimal set of equations that can be solved to compute each measurement variable is the first problem addressed in the example implementations. A set of equations for solving a variable is minimal if no subset of equations can be used to solve the variable.

The set of equations to solve for each measurement is not unique. Different sets of equations can be used to calculate each measurement. The generated residuals for each measurement can be sensitive to different sets of faults. To achieve maximum diagnostically, all the determined equation sets for each measurement are determined.

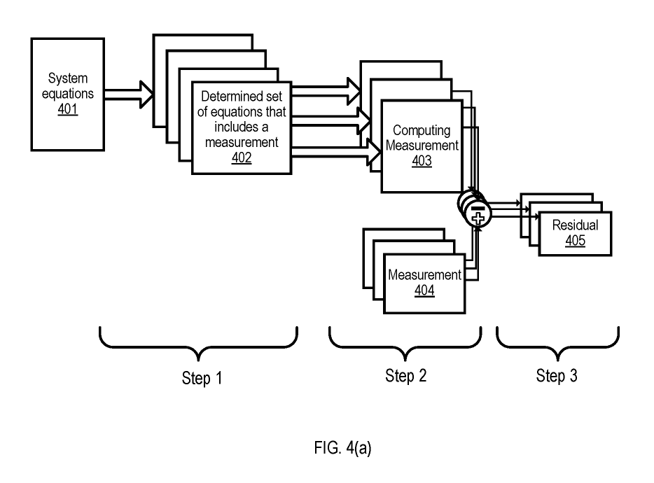

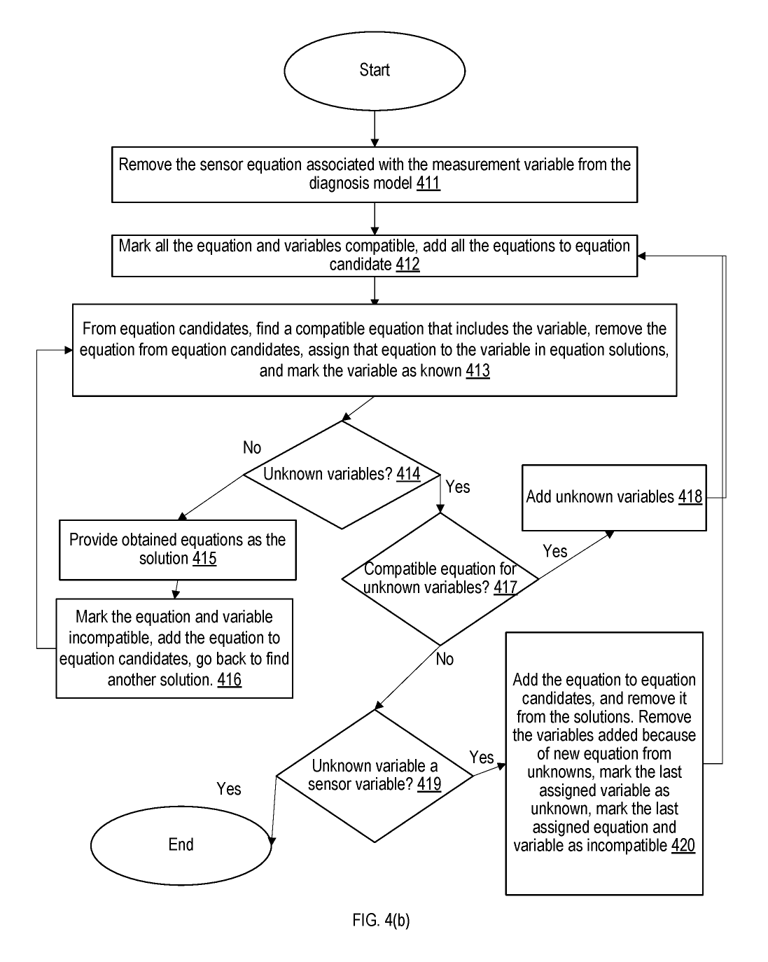

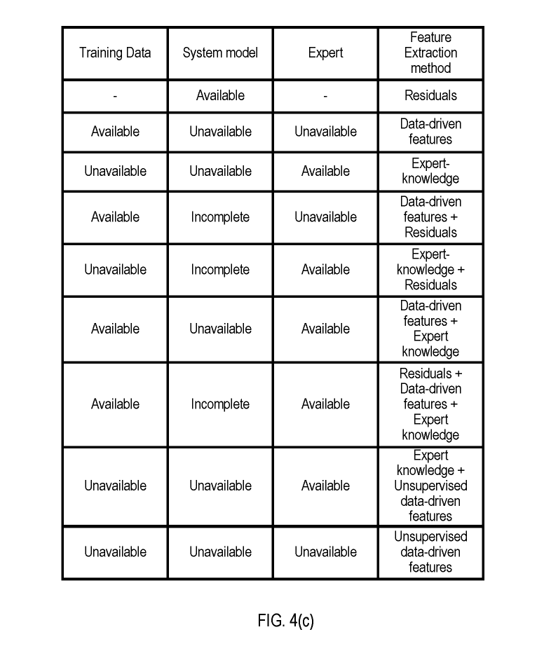

FIG. 4(a) illustrates the residual generation method, in accordance with an example implementation. The residual generation method involves dividing the system equation set into sets of minimal determined equations which include measurement variables (step 1), solving each determined set of equation for a measurement variable (step 2), and generating residuals as the differences between measurements and computed values for the measurements (step 3). First, an algorithm is developed to find a minimal set of equations to compute each measurement for the system equations 401 provided.

In example implementations described herein, the problem of finding a minimal determined set of equations is formulated for computing each measurement variable as a matching problem, wherein a matching algorithm can be utilized to solve it. Finding a determined set of equations which includes a measurement variable can be formulated as a matching problem as follows. Consider the set of equations and variables as the nodes of a bipartite graph. An equation connected to a variable means the equation can be used to solve the variable. Each equation can solve one and only one of its variables. A determined set of equations for solving a measurement represents a complete matching between the set of equations and their variables. Each sensor can be represented with an equation that relates sensor measurement to the measured variable. The diagnosis model is a combined set of system equations and sensor equations. To find a determined set of equations for each measurement variable from a diagnosis model, the flow of FIG. 4(b) is executed as follows:

FIG. 4(b) illustrates an example flow for finding determined sets of equations, in accordance with an example implementation. Specifically, the flow of FIG. 4(b) is the flow executed during step 1 at 402 of FIG. 4(a). At 411, the sensor equation associated with the measurement variable is removed from the diagnosis model. At 412, all the equations and variables are marked as compatible an all the equations are considered equation candidates. At 413, a compatible equation that has the removed variables is obtained, wherein the equation is assigned to the removed variable, the variable is then marked as known and the equation is removed from equation candidates, and is added to the equation solutions. At 414, a determination is made as to whether the obtained equations have any other unknown variable, or if there are more unknown variables to be processed. If the equation does not have any other unknown variable (no), then the equations obtained through the process of FIG. 4(b) thus far are utilized as a determined set of equations. The equation set is saved as the answer at 415 as the process had iterated until there was no unknown variable in the set of equations. At 416, the algorithm marks the last assigned equation and variable as incompatible, adds back the equation to the equation candidates. Then the flow proceeds back to 413 to determine other solutions. If the equation has other unknown variables (Yes at 414), 417 determines if there is compatible equation for that unknown variable. If (yes) the unknown variables are added to the set of unknown variables that needs to be solved at 418. To solve each unknown variable, a new equation needs to be added to include the variable, so the flow returns to 413 to process the unknown variables. If there is no compatible equation, the system checks if the unknown variable is the original sensor variable at 419, if (yes) we have found all the determined sets and the algorithm stops, if (no) we remove the last equation added to equation solutions from the equation solutions and add it back to equation candidates, mark the last assigned equation and variable incompatible, and remove all of the variables added to the unknown variables because of that equation from the set of unknown variables at 420. Then, we go back find another equation for the last assigned variable at 413. To generate all the possible residuals, the flow at FIG. 4(b) is iterated for each measurement variable. Next, a numerical approach is applied to solve each set of equations for the measurement variables.

Solving determined sets to compute the measurements at 403. The difference between computed measurements using determined equations at 403, and the actual sensor measurements 404, is the residuals 405.

In the related art, there are analytical solutions, simulation-based solutions and bond graph based solutions for automated residual generation. However, in many practical cases because of the nonlinearity and non-invertibility of system functions, it is not possible to derive closed form solutions for the residuals or even develop computational models such as computer simulators and bond graph models to simulate their behavior. System behavior can be described by implicit functions. Implicit functions describe the mathematical relationship between system variables. However, the variables cannot be written as a function of other variables explicitly and therefore, it is not possible to derive closed form solutions. In simulations, such implicit functions can lead to an algebraic loop, where a block input depends on the value of its own output.

In example implementations, adopting a numerical approach for residual generation problem makes the diagnosis algorithm suitable for nonlinear systems with algebraic loops, and non-invertible and implicit functions. Numerical methods can approximate the value of residuals when an analytical solution cannot be derived. Moreover, the numerical approach of example implementations can be extended to solve the fault identification problem. In example implementations, the following numerical method is applied to solve determined sets for measurement variables and conducting the computing of the measurement 403:
At each sample point, consider the previous value of variables as the initial point.
Adopt a numerical approach (e.g., Newtons method) to solve for the measurement current value iteratively.

The example implementations described herein can thereby be configured to solve a set of nonlinear equations at each sample point and therefore, although computationally more expensive than the previous approaches, example implementations can generate residuals for nonlinear systems with implicit functions.

Data driven feature extraction 404: when the system model is not available, example implementations can use data-driven methods to extract features. Moreover, when the model is incomplete or uncertain, data-driven features can be used in addition to the residuals 405 to improve diagnosis performance. In example implementations, the data-driven methods use the entire set of measurements as the features. For high dimensional data, such implementations increase the required time and space for processing the data, and can mask the effect of faults. Typically, many features in the dataset will be irrelevant to a fault. The irrelevant features may hurt fault detection by acting as noise and hiding effects on the relevant features. Based on the available data, example implementations can apply supervised or unsupervised feature selection techniques. When labeled training data is available, example implementations can utilize mutual information between features and fault classes to select a subset of features with highest mutual information with fault classes for fault detection and isolation in high dimensional datasets. In an example implementation, the iteration can proceed as follows.

1. For each fault in the system, extract the historical data associated with the fault and normal operation, and select the set of features with highest mutual information with normal class and the fault class for fault detection. Such features are extracted because of their importance in detecting the fault.

2. For each pair of faults, extract the historical data associated with the faults, and select the set of features with highest mutual information with these two fault classes. Such features are selected because of their importance in isolating the two faults from each other.

When labeled data is not available, example implementations use unsupervised methods for feature selection according to any desired implementation as known in the art. FIG. 4(c) illustrates example feature extraction methods that can be applied in example diagnosis software and systems, in accordance with an example implementation.

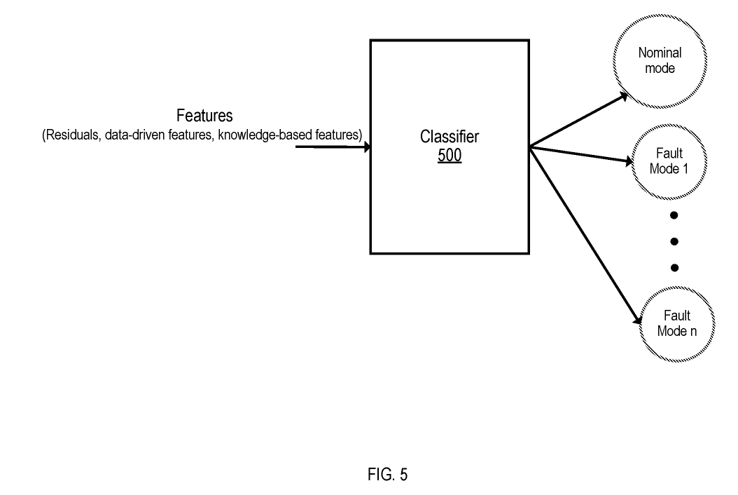

FIG. 5 illustrates an example of fault detection and isolation through using classifiers in accordance with an example implementation. When training data for both normal operation and faulty operation is available, example implementations can utilize a classifier 500 such as support vector machine to distinguish fault modes from nominal operation. The input to the classifier is the set of features and the output is the system operation modes. FIG. 5 represents the fault diagnosis step when the training data is available for normal and fault modes.

Using classifiers can improve diagnosis performance, however data indicative of faults is not always available for training. When a system only has access to normal data or has access to the system model to generate normal data, hypothesis tests are applied to distinguish features in their normal range from abnormal features. In general, hypothesis tests only require nominal data parameters. For example, Z-test requires the means and variances of features in normal operation and, therefore, can be applied when faulty data is not available. The system is in a fault mode when one or more features are detected out of their nominal operating ranges. A decision logic unit uses the set of features out of nominal interval to isolate the fault mode.

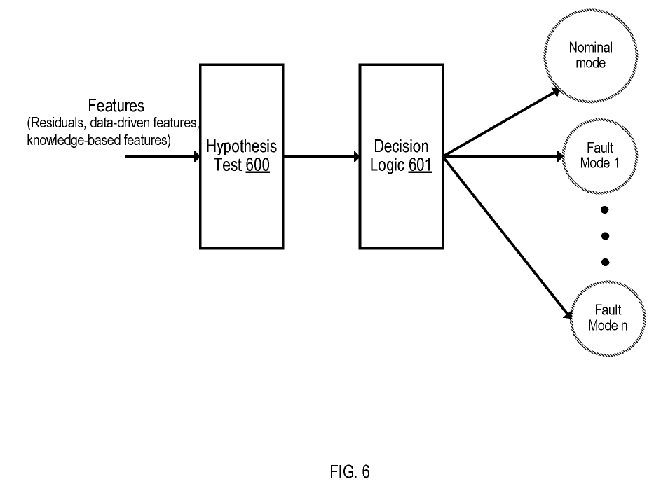

FIG. 6 illustrates an example usage of the hypothesis test 600 and decision logic 601 for fault detection and isolation, in accordance with an example implementation. Specifically, FIG. 6 represents a fault diagnosis step when the training data is only available for normal operation. Note that the decision logic 601 requires additional information from the system. Such information can be extracted from system equations.

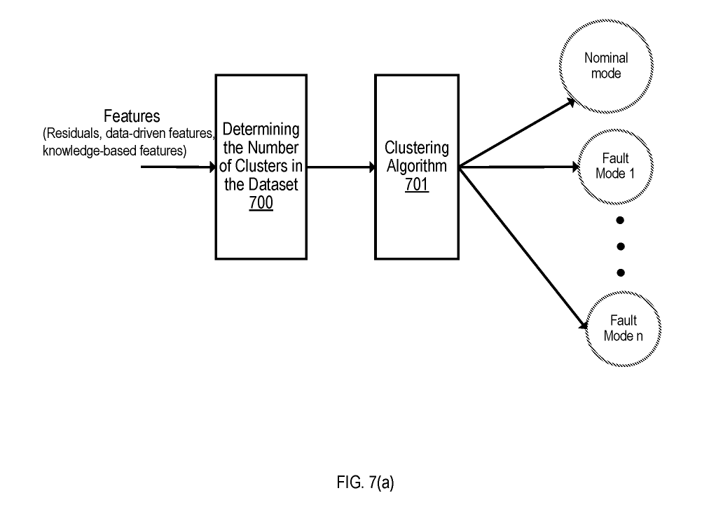

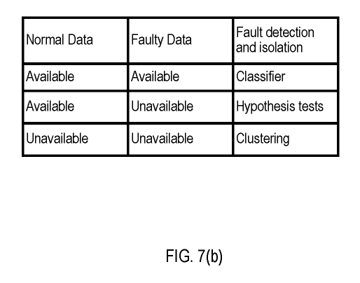

FIG. 7(a) illustrates an example of utilizing an unsupervised approach for fault detection and isolation, in accordance with an example implementation. When data indicative of normal status is not available, it is reasonable to assume that there is no fault in the early stages of operation and therefore, the data in this operational period is normal. However, in many cases, the data from the early stages is not available for all the operating modes of the system. In this situation, example implementations can apply an unsupervised method to detect and isolate fault modes. In an example execution of an unsupervised method, at the first step, an algorithm 700 can be applied such as the Calinski and Harabasz method to detect the number of clusters in the dataset. Next, a clustering algorithm 701 such as hierarchical clustering can be applied to detect the clusters in the dataset. The small clusters are candidates for the fault modes. FIG. 7(a) illustrates an example implementation of the fault diagnosis step when the training data is not available. FIG. 7(b) illustrates examples of different fault diagnosis methods that can be implemented based on different scenarios involving the availability of normal data and data indicative of faults.

Fault Identification

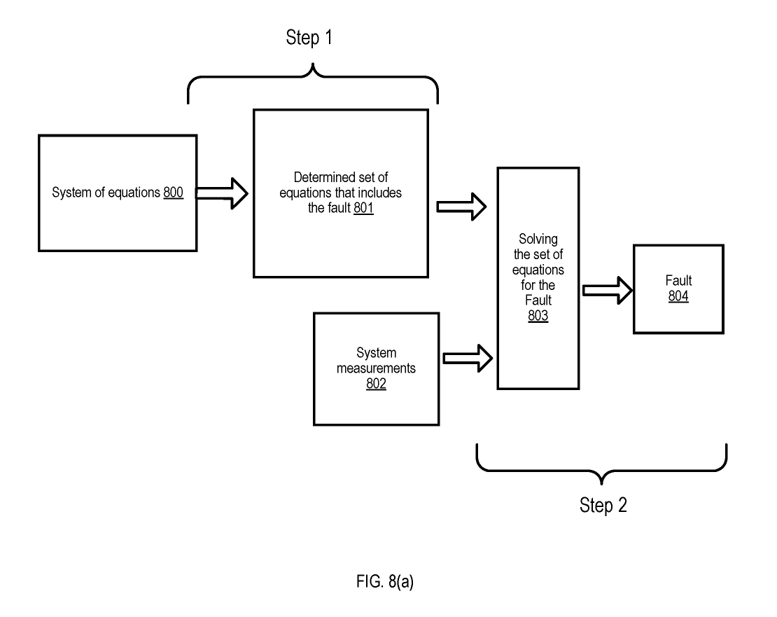

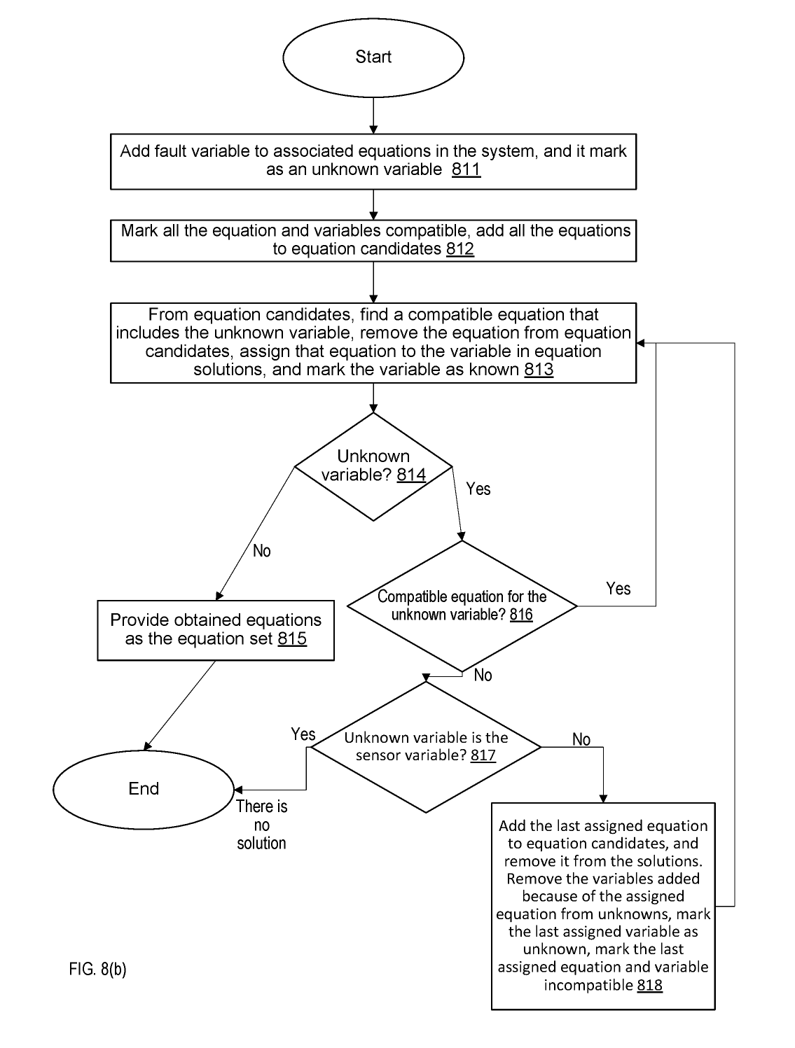

Fault identification follows the fault detection and isolation step. In example implementations described herein, the numerical residual generation method is modified to address fault identification problem. FIG. 8(a) illustrates the fault identification method, in accordance with an example implementation. In example implementations as shown at FIG. 8(a), there are two main steps: 1) given the system equations 800, finding a set of determined equations 801 which includes the fault, and 2) from the determined set of equations and the system measurements 802, solving the determined set of equations for the fault 803 to determine the faults 804. To find a minimal set of equations to compute each fault, the matching algorithm are modified as shown in the flow of FIG. 8(b).

FIG. 8(b) illustrates a flow for finding determined sets for fault identification, in accordance with an example implementation. Specifically, FIG. 8(b) illustrates the flow executed at 801 of FIG. 8(a). At 811, after a fault mode is detected and isolated from the other fault candidates in the system, the system adds the fault variable to its associated equations in the system and marks the fault variable as an unknown variable at 811. It then marks all the equations and variables compatible and considers all the equations as equation candidates at 812. Then at 813, the system selects one of the compatible equations that has the unknown variable, assigns that equation to the variable, and marks the unknown variable as a known variable. At 814, a determination is made as to whether the selected equation has other unknown variables. If the equation does not have any other unknown variable (No), the system has found a determined set of questions, which are provided at 815. The system saves the equation set as the answer at 815. If the equation has other unknown variables (Yes), then the system should determine if there is a compatible equation for the unknown variable at 816. When there is no compatible equation for the unknown variable at 816, the system determines if the unknown variable is the original fault variable or not at 817. If so (Yes), then there is no solution to identify this fault. Otherwise (No), the system sets the last assigned variable and equation as incompatible, removes the last assigned equation form the solution and adds it back to equation candidates, marks the last assigned variable as unknown at 818 and goes back to 813 to find a compatible equation for the unknown variable.

After a set of determined equations which includes the fault is selected, the system measurements 802 during the fault period are used to numerically solve for the fault variable as follows. To compute the fault value, at each sample point, the previous value of fault and other variables in the selected determined set of equations are considered as the initial value to be utilized in Newton's method. Newton's method is repeated until the fault value and other variables in the selected determined set of equations converge.

The applications of the residual generation method for model-based feature generation, the general framework in combining model-based and data-driven diagnosis methods, and the proposed approach for fault identification are presented in the following example implementations.

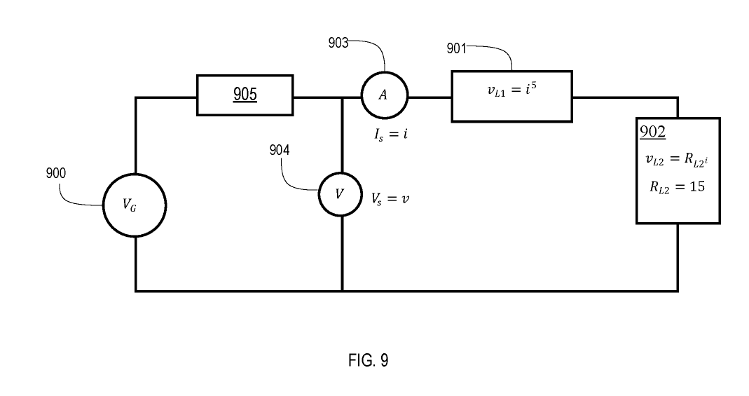

FIG. 9 illustrates a nonlinear electric circuit system, in accordance with an example implementation. The example circuit system has components which include generator 900, nonlinear load 901, linear load 902, current sensor (amperemeter) 903 and, voltage sensor (voltmeter) 904. Assume the generator internal resistance (represented by box 905) is unknown and the linear load 902 is R_{L2}=15Ω. The voltmeter 904 reads the voltage across the loads, Vₛ, and the amperemeter 903 reads the current, Iₛ.

The set of system equations are:

e₁:v_{L1}=i⁵,

e₂:v_{L2}=15i,

e₃:v=v_{L1}+v_{L2},

e₄:v=Vₛ,

e₅:i=Iₛ, (1)

where v_{L1} is the voltage across nonlinear load, v_{L2} is the voltage across the linear load, i represents the circuit current, and v represents the generator output voltage. Note that since the generator internal resistance 905 is unknown, there is no equation that describes the relationship between the generator voltage, V_{G}, and other system variables.

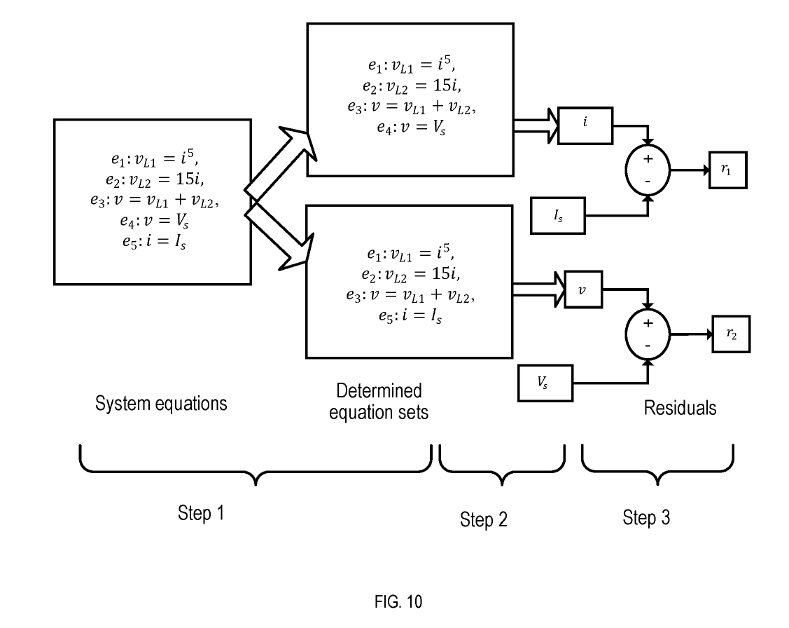

FIG. 10 illustrates an example residual generation for the electric circuit of FIG. 9. The set of equations are provided as the inputs to the residual generation system as shown in FIG. 10. In the first step (Step 1), the residual generation algorithm finds two sets of determined equations among the system equations:

e₁:v_{L1}=i⁵,

e₂:v_{L2}=15i,

e₃:v=v_{L1}+v_{L2},

e₄:v=Vₛ (2)

e₁:v_{L1}=i⁵,

e₂:v_{L2}=15i,

e₃:v=v_{L1}v_{L2},

e₅:i=Iₛ (3)

The first selected set shown in equation (2) includes four equations, {e₁,e₂,e₃,e₄}, and four unknown variables, {v_{L1},i,v_{L2},v}. The algorithm uses this set of equations to solve i. However, it is well known that there is no analytical solution for these set of equations. Therefore, none of the previous solutions for residual generation can generate a residual from the first selected set. Thus, example implementations utilize a numerical approach to solve for i in the second step (Step 2). The difference between the computed i and measured current Iₛ is a residual. For example, consider the case where Vₛ=4V, and Iₛ=0.98 A. The algorithm substitutes Vₛ=4V in equation (2) and then uses Newton's method to calculate i=0.27 A. The difference between the measured current, Iₛ, and the calculated current, i, is the value of the first residual at this operating point: r₁=Iₛ−i=0.98−0.27=0.71.

The second selected set shown in equation (3) also includes four equations, {e₁,e₂,e₃,e₅}, and four unknown variables, {v_{L1},i,v_{L2},v}. Note that the unknown variables are the same in these two sets, but the set of equations to be used for solving them are different. In the second set, the algorithm uses {e₁,e₂,e₃,e₅} to solve for v. The difference between the measured voltage, Vₛ, and the calculated voltage, v, is the value of the second residual: r₂=Vₛ−v. For this simple example, the algorithm only generates two residuals, however, the number of residuals grows exponentially as the number of measurements increases in the system. In the next step (Step 3), the application of the common framework in integrating two solutions for fault diagnosis in the nonlinear electric circuit is described below.

Using the Common Framework to Integrate Diagnosis Solutions

Consider the case where there are three possible faults in the electric circuit shown in FIG. 9; 1) current sensor fault, f₁ 2) voltage sensor fault, f₂, and 3) generator fault, f₃. The value of generator internal resistance 904 is unknown. Consider 5% parameter uncertainty in the linear resistance load, and an additive 5% noise in the sensors. Further consider the generator voltage V_{G}=24 cos(t) and the following fault scenarios in the training data:

1—f₁ (current sensor fault) occurs from 50 s to 200 s.

2—f₂ (voltage sensor fault) occurs from 300 s to 350 s.

3—f₃ (generator internal resistance fault) occurs from 400 s to 500 s.

For the test dataset, consider V_{G}=24 sin(t), and the following fault scenarios:

1—f₂ (voltage sensor fault) occurs from 100 s to 200 s.

2—f₃ (generator internal resistance fault) occurs from 250 s to 350 s.

3—f₁ (current sensor fault) occurs from 400 s to 500 s.

To apply a model-based fault detection and isolation, the generated residuals, r₁ and r₂, are used with a hypothesis test. r₁ and r₂ are both sensitive to f₁ and f₁ and can be used to detect these faults. However, they cannot isolate the faults from each other or detect f₃. Therefore, by applying the model-based approach to test data, a 40% false negative can be obtained at the best scenario for the above example. The false positive rate depends on the hypothesis tests and the noise in the data. Since only 5% noise is considered in the sensors, a hypothesis test with zero false positive rate can be designed.

An alternative approach is to use a data-driven method for FDI. Select the input and the measurements (generator nominal voltage, voltmeter, and amperemeter) as the set of features. Then, use the training data to train a support vector machine (SVM) classifier with Gaussian kernel for the four classes (1—nominal, 2—f₁, 3—f₂ and 4—f₃). Applying the model to the test data, a 0% false positive rate, and 13% false negative rate is obtained. Although this is an improvement, the proposed framework to combine the model-based method and the data-driven approach can be utilized to achieve even a better diagnosis performance. To integrate the methods, the residuals are combined with the data-driven features (generator nominal voltage, voltmeter, and amperemeter), and the training data is used to train a similar SVM classifier for the four classes of operation (1—nominal, 2—f₁, 3—f₂ and 4—f₃). Applying the model to the test data, a 0% false positive rate, and 1.8% false negative rate is obtained. This example shows the significant diagnosis improvement that can be achieved by using the proposed common framework to integrate different diagnosis methods as described herein. In the next section, example advantages of the numerical approach for fault identification are illustrated.

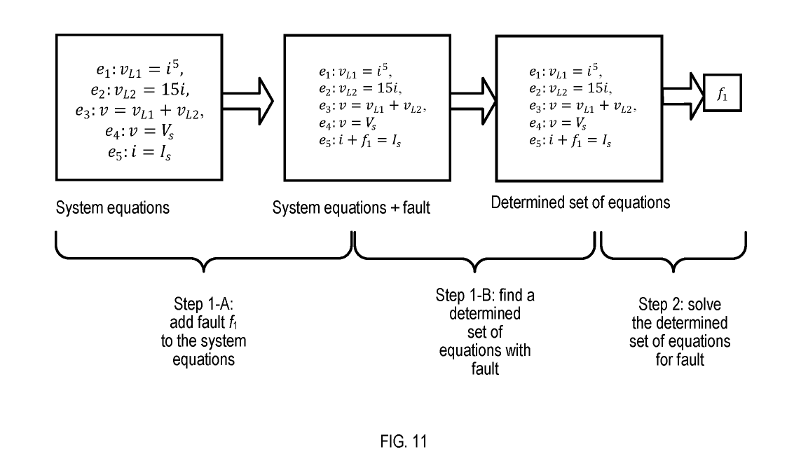

FIG. 11 illustrates an example fault identification for the electric circuit system of FIG. 9.

Consider the amperemeter fault f₁. After this fault mode is detected and isolated using the proposed integrated method, the fault identification algorithm substitutes this fault in the set of equations at Step 1-A to find a determined set of equations for fault identification at Step 1-B. The algorithm finds the entire set of equations with f₁, as a determined set:

e₁:v_{L1}=i⁵,

e₂:v_{L2}=15i,

e₃:v=v_{L1}+v_{L2},

e₄:v=V_{S}

e₅:i+f₁=Iₛ (4)

Vₛ and Iₛ are sensor measurements. Therefore, the selected set includes five equations, {e₁,e₂,e₃,e₄,e₅}, and five unknown variables, v_{L1},v_{L2},v,f₁. However, it is well known that there is no analytical solution for this set of equations. Consider a scenario where Iₛ=1.25 A, and Vₛ=10V. Even though, there is no analytical solution for (4), the proposed method uses Newton's method as a numerical approach to estimate f₁≅0.592 at Step 2.

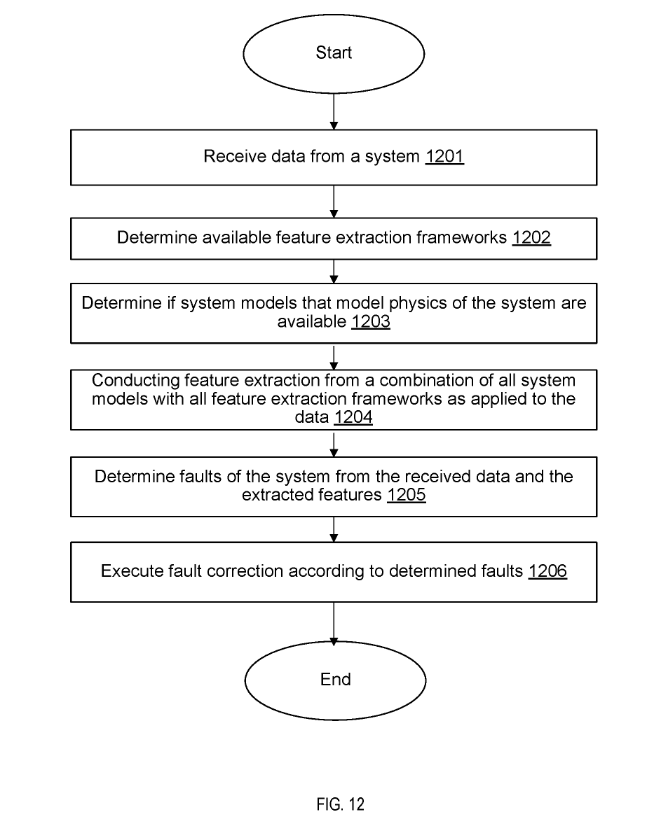

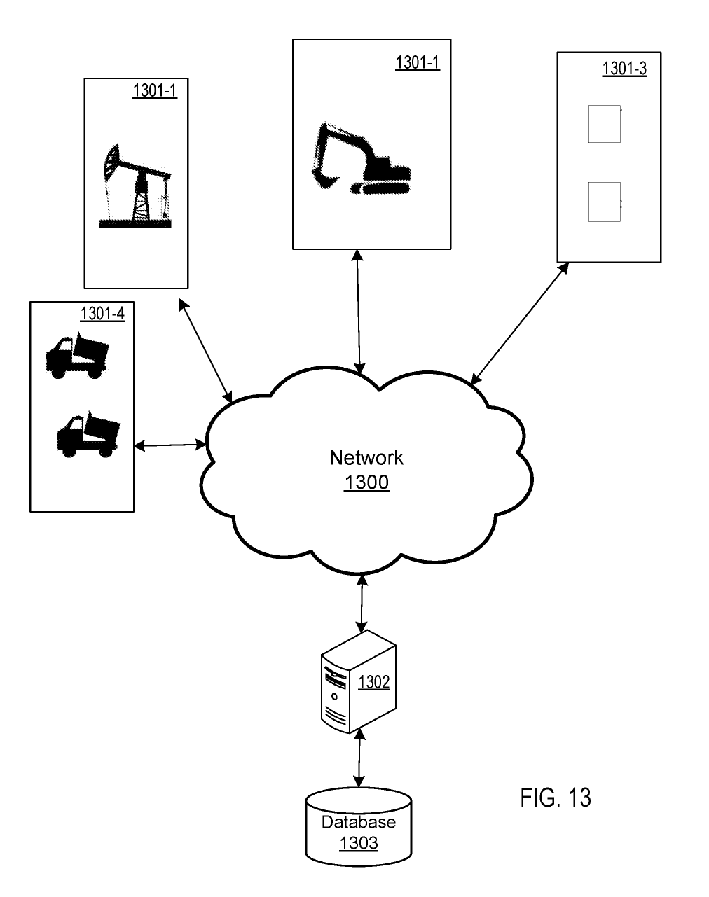

FIG. 12 illustrates an example overall flow, in accordance with an example implementation. In an example overall flow, the process begins from receiving data from a system from the plurality of systems 1201 as illustrated in FIG. 13. At 1202, the process determines available feature extraction frameworks of the system from the plurality of systems, the available feature extraction frameworks determined based on availability of system models, domain knowledge-based features, and data driven features of the system based on referencing the parameters of the system with management information for feature extraction frameworks illustrated in FIG. 4(c). At 1203, the process determines if the system models that model physics (e.g., models output physical measurement variables) of the system are available. At 1204, for the system models that model physics of the system determined to be available based on referencing the available system models of the system, the process conducts feature extraction for the system from a combination of all of the available system models with all available feature extraction frameworks as applied to the received data to derive extracted features as illustrated in FIGS. 4(a), 4(b), and 10; and at 1205, the process determine faults of the system from the extracted features and the received data as illustrated in FIGS. 8(a), 8(b) and 11. Once the faults are determined, the execution of fault correction according to determined faults can be conducted at 1206. Such fault correction can include changing inputs to the system based on the determined features to eliminate the fault, or to bring the system down for physical maintenance, or other real world implementations in according to the desired implementation.

FIG. 13 illustrates a plurality of systems and a management apparatus, in accordance with an example implementation. One or more systems 1301-1, 1301-2, 1301-3, and 1301-4 are communicatively coupled to a network 1300 which is connected to a management apparatus 1302. The management apparatus 1302 manages a database 1303, which contains data feedback aggregated from the systems in the network 1300. In alternate example implementations, the data feedback from the systems 1301-1, 1301-2, 1301-3, and 1301-4 can be aggregated to a central repository or central database such as proprietary databases that aggregate data from systems such as enterprise resource planning systems, and the management apparatus 1302 can access or retrieve the data from the central repository or central database. Such systems can include stationary apparatuses such as coolers, air conditioners, servers, as well as mobile apparatuses such as automobiles, trucks, cranes, as well as any other apparatuses that undergo periodic maintenance and that are monitored for fault detection.

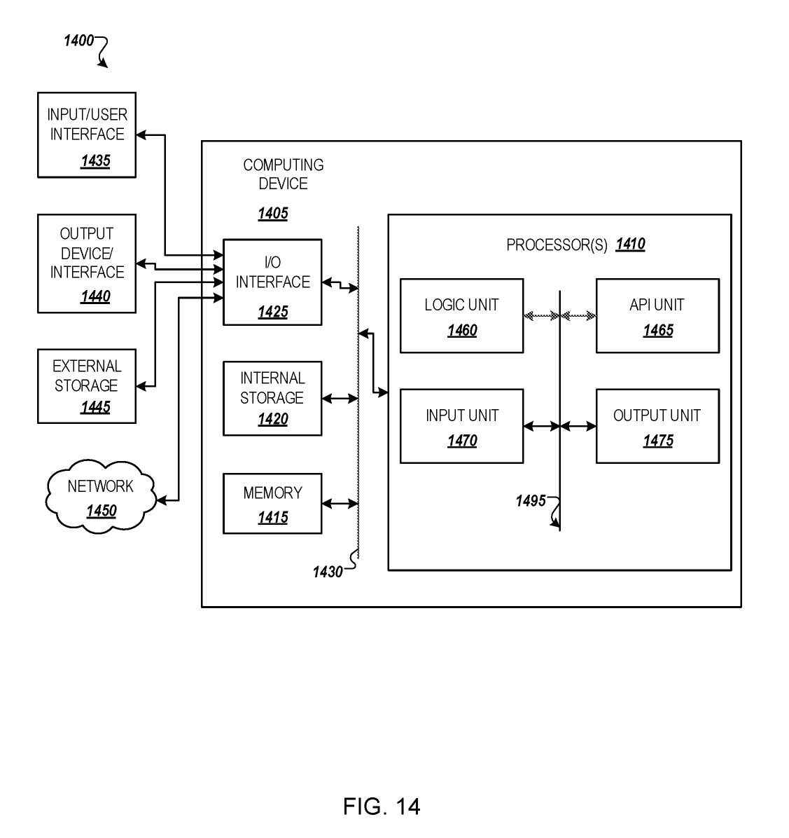

FIG. 14 illustrates an example computing environment with an example computer device suitable for use in some example implementations, such as a management apparatus 1302 as illustrated in FIG. 13. Functionality described herein can be implemented at the management apparatus 1302, or facilitated through a system based on some combination of elements, depending on the desired implementation.

Computer device 1405 in computing environment 1400 can include one or more processing units, cores, or processors 1410, memory 1415 (e.g., RAM, ROM, and/or the like), internal storage 1420 (e.g., magnetic, optical, solid state storage, and/or organic), and/or I/O interface 1425, any of which can be coupled on a communication mechanism or bus 1430 for communicating information or embedded in the computer device 1405. I/O interface 1425 is also configured to receive images from cameras or provide images to projectors or displays, depending on the desired implementation.

Computer device 1405 can be communicatively coupled to input/user interface 1435 and output device/interface 1440. Either one or both of input/user interface 1435 and output device/interface 1440 can be a wired or wireless interface and can be detachable. Input/user interface 1435 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1440 may include a display, television, monitor, printer, speaker, braille, or the like. In some example implementations, input/user interface 1435 and output device/interface 1440 can be embedded with or physically coupled to the computer device 1405. In other example implementations, other computer devices may function as or provide the functions of input/user interface 1435 and output device/interface 1440 for a computer device 1405.

Examples of computer device 1405 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1405 can be communicatively coupled (e.g., via I/O interface 1425) to external storage 1445 and network 1450 for communicating with any number of networked components, devices, and systems, including one or more computer devices of the same or different configuration. Computer device 1405 or any connected computer device can be functioning as, providing services of, or referred to as a server, client, thin server, general machine, special-purpose machine, or another label.

I/O interface 1425 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1400. Network 1450 can be any network or combination of networks (e.g., the Internet, local area network, wide area network, a telephonic network, a cellular network, satellite network, and the like).

Computer device 1405 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1405 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1410 can execute under any operating system (OS) (not shown), in a native or virtual environment. One or more applications can be deployed that include logic unit 1460, application programming interface (API) unit 1465, input unit 1470, output unit 1475, and inter-unit communication mechanism 1495 for the different units to communicate with each other, with the OS, and with other applications (not shown). The described units and elements can be varied in design, function, configuration, or implementation and are not limited to the descriptions provided.

In some example implementations, when information or an execution instruction is received by API unit 1465, it may be communicated to one or more other units (e.g., logic unit 1460, input unit 1470, output unit 1475). In some instances, logic unit 1460 may be configured to control the information flow among the units and direct the services provided by API unit 1465, input unit 1470, output unit 1475, in some example implementations described above. For example, the flow of one or more processes or implementations may be controlled by logic unit 1460 alone or in conjunction with API unit 1465. The input unit 1470 may be configured to obtain input for the calculations described in the example implementations, and the output unit 1475 may be configured to provide output based on the calculations described in example implementations.

Memory 1415 is configured to store management information as illustrated in FIG. 4(c) to compare the parameters of the system based on the availability of the models, domain knowledge-based features and training data to determine available feature extraction frameworks, and FIG. 7(c) to compare the availability of data indicative of normal operation and availability of data indicative of faulty operation of the system to determine the classification or clustering method to be utilized.

Processor(s) 1410 can be configured to execute the flow diagrams of FIGS. 4(b), 8(b) and 12. For example, in executing FIG. 12, processor(s) 1410 can be configured to determine available feature extraction frameworks of the system from the plurality of systems, the available feature extraction frameworks determined based on availability of system models, domain knowledge-based features, and data driven features of the system in comparison with management information for feature extraction frameworks illustrated in FIG. 4(c). Processor(s) 410 can be configured to determine if the system models that model physics (e.g., models output physical measurement variables) of the system are available as illustrated in FIG. 9. For the system models that model physics of the system determined to be available based on referencing the available system models of the system, processor(s) 1410 can conduct feature extraction for the system from a combination of all of the available system models with all available feature extraction frameworks as applied to the received data to derive extracted features as illustrated in FIGS. 4(a), 4(b), and 10; and determine faults of the system from the extracted features and the received data as illustrated in FIGS. 8(a), 8(b) and 11. Once the faults are determined, processor(s) 1410 can correct the determined faults by transmitting instructions to the system to change certain inputs, to shut the system down for maintenance, or through other implementations in accordance with the desired implementation. In this manner, the management apparatus 1302 can act as a control system to implement real world corrections to faults in the managed systems according to the determined faults.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for fault detection by an apparatus managing a plurality of systems, the method comprising:
receiving data from a system from the plurality of systems;
determining available feature extraction frameworks of the system from the plurality of systems, the available feature extraction frameworks determined based on availability of system model, domain knowledge-based features, and data driven features;
determining if the system models that model physics of the system are available from the available feature extraction frameworks;
conducting feature extraction for the system from a combination of all available feature extraction frameworks as applied to the received data to derive extracted features;
determining faults of the system from the extracted features and the received data; and
conducting fault identification for the system models that model physics of the system being determined to be available.

2. The method of claim 1, wherein the conducting feature extraction for the system from a combination of all available feature extraction frameworks as applied to the received data to derive extracted features, comprises applying the available system model of the feature extraction framework by:
for each measurement variable of the available system models that model physics of the system:
finding an equation that has the each measurement variable, assign the equation to the each measurement variable, and mark the each measurement variable as being known;
for the equation having one or more variables not marked as being known, finding the equation for each of the one or more variables not marked as being known;
determining an equation set from the available system model from found equations that include measurements;
conducting numerical analysis on the found equations to estimate values for the each measurement variable; and
determining residuals based on a difference between the estimated value and an actual measurement value from the received data for the each measurement variable.

3. The method of claim 1, wherein the determining faults of the system comprises conducting fault detection and isolation based on the residuals, the fault detection and isolation comprising:
combining residuals with data-driven ones and domain knowledge ones of the extracted features; and
applying a classification or clustering method on the combined residuals and data-driven and domain knowledge ones of the extracted features to detect and isolate faults according to fault modes and nominal modes, the detected and isolated faults comprising fault variables.

4. The method of claim 1, wherein conducting fault identification if system model is available, comprises:
for each fault variable of the fault variables:
finding a fault equation that has the each fault variable, assign the fault equation to the each fault variable, and mark the each fault variable as being known;
for the equation having one or more variables not marked as being known, finding the equation for each of the one or more variables not marked as being known;
determining an equation set from the available system model from found equations that include the fault variables; and
conducting numerical analysis on the found equations to estimate values for the each fault variable.

5. The method of claim 3, wherein the classification or clustering method is selected based on availability of data indicative of normal operation and availability of data indicative of faulty operation.

6. The method of claim 1, wherein determining available feature extraction frameworks of the system from the plurality of systems is conducted according to referencing management information indicative of available feature extraction methods corresponding to availability of the system models, availability of the domain knowledge-based features, and availability of training data, and determining ones of the available feature extraction methods for inclusion in the available feature extraction frameworks.

7. A non-transitory computer readable medium, storing instructions for fault detection by an apparatus managing a plurality of systems, the method comprising:
receiving data from a system from the plurality of systems;
determining available feature extraction frameworks of the system from the plurality of systems, the available feature extraction frameworks determined based on availability of system model, domain knowledge-based features, and data driven features ;
determining if the system models that model physics of the system are available from the available feature extraction frameworks;
conducting feature extraction for the system from a combination of all available feature extraction frameworks as applied to the received data to derive extracted features;
determining faults of the system from the extracted features and the received data; and
conducting fault identification for the system models that model physics of the system being determined to be available.

8. The non-transitory computer readable medium of claim 7, wherein the conducting feature extraction for the system from a combination of all available feature extraction frameworks as applied to the received data to derive extracted features, comprises applying the available system model of the feature extraction framework by:
for each measurement variable of the available system models that model physics of the system:
finding an equation that has the each measurement variable, assign the equation to the each measurement variable, and mark the each measurement variable as being known;
for the equation having one or more variables not marked as being known, finding the equation for each of the one or more variables not marked as being known;
determining an equation set from the available system model from found equations that include measurements;
conducting numerical analysis on the found equations to estimate values for the each measurement variable; and
determining residuals based on a difference between the estimated value and an actual measurement value from the received data for the each measurement variable.

9. The non-transitory computer readable medium of claim 7, wherein the determining faults of the system comprises conducting fault detection and isolation based on the residuals, the fault detection and isolation comprising:
combining residuals with data-driven ones and domain knowledge ones of the extracted features; and
applying a classification or clustering method on the combined residuals and data-driven and domain knowledge ones of the extracted features to detect and isolate faults according to fault modes and nominal modes, the detected and isolated faults comprising fault variables.

10. The non-transitory computer readable medium of claim 7, wherein the conducting fault identification if system model is available comprises:
for each fault variable of the fault variables:
finding a fault equation that has the each fault variable, assign the fault equation to the each fault variable, and mark the each fault variable as being known;
for the equation having one or more variables not marked as being known, finding the equation for each of the one or more variables not marked as being known;
determining an equation set from the available system model from found equations that include the fault variables; and
conducting numerical analysis on the found equations to estimate values for the each fault variable.

11. The non-transitory computer readable medium of claim 10, wherein the classification or clustering method is selected based on availability of data indicative of normal operation and availability of data indicative of faulty operation.

12. The non-transitory computer readable medium of claim 7, wherein determining available feature extraction frameworks of the system from the plurality of systems is conducted according to referencing management information indicative of available feature extraction methods corresponding to availability of the system models, availability of the domain knowledge-based features, and availability of training data, and determining ones of the available feature extraction methods for inclusion in the available feature extraction frameworks.

13. A management apparatus configured to manage a plurality of systems, the management apparatus comprising:
a processor, configured to:
receive data from a system from the plurality of systems;
determine available feature extraction frameworks of the system from the plurality of systems, the available feature extraction frameworks determined based on availability of system model, domain knowledge-based features, and data driven features ;
determine if the system models that model physics of the system are available from the available feature extraction frameworks;
conduct feature extraction for the system from a combination of all available feature extraction frameworks as applied to the received data to derive extracted features;
determine faults of the system from the extracted features and the received data; and
conduct fault identification for the system models that model physics of the system being determined to be available.

14. The management apparatus of claim 13, wherein the processor is configured to conduct feature extraction for the system from a combination of all available feature extraction frameworks as applied to the received data to derive extracted features, through applying the available system model of the feature extraction framework by:
for each measurement variable of the available system models that model physics of the system:
finding an equation that has the each measurement variable, assign the equation to the each measurement variable, and mark the each measurement variable as being known;
for the equation having one or more variables not marked as being known, finding the equation for each of the one or more variables not marked as being known;
determining an equation set from the available system model from found equations that include measurements;
conducting numerical analysis on the found equations to estimate values for the each measurement variable; and
determining residuals based on a difference between the estimated value and an actual measurement value from the received data for the each measurement variable.

15. The management apparatus of claim 13, wherein the processor is configured to determine faults of the system through conducting fault detection and isolation based on the residuals by:
combining residuals with data-driven ones and domain knowledge ones of the extracted features; and
applying a classification or clustering method on the combined residuals and data-driven and domain knowledge ones of the extracted features to detect and isolate faults according to fault modes and nominal modes, the detected and isolated faults comprising fault variables.

16. The management apparatus of claim 13, wherein the processor is configured to conduct fault identification if system model is available by:
for each fault variable of the fault variables:
finding a fault equation that has the each fault variable, assign the fault equation to the each fault variable, and mark the each fault variable as being known;
for the equation having one or more variables not marked as being known, finding the equation for each of the one or more variables not marked as being known;
determining an equation set from the available system model from found equations that include the fault variables; and
conducting numerical analysis on the found equations to estimate values for the each fault variable.

17. The management apparatus of claim 16, wherein the classification or clustering method is selected based on availability of data indicative of normal operation and availability of data indicative of faulty operation.

18. The management system of claim 13, wherein the processor is configured to determine available feature extraction frameworks of the system from the plurality of systems according to referencing management information indicative of available feature extraction methods corresponding to availability of the system models, availability of the domain knowledge-based features, and availability of training data, and determining ones of the available feature extraction methods for inclusion in the available feature extraction frameworks.
